(19) United States
(12) Patent Application Publication
(10) Pub. No.: US 2022/0270049 A1
(43) Pub. Date: Aug. 25, 2022

(54) A SYSTEM AND METHOD FOR AN INTERACTIVE ACCESS TO PROJECT DESIGN AND SPACE LAYOUT PLANNING

(71) Applicant: ROOT'S DECOR INDIA PVT LTD., Gujarat (IN)

(72) Inventor: Nilamkumar Jayntilal PATEL, Gujarat (IN)

(21) Appl. No.: 17/631,771

(22) PCT Filed: Jan. 13, 2020
(86) PCT No.: PCT/IN2020/050039

§ 371 Date: Jan. 31, 2022

(30) Foreign Application Priority Data
Aug. 5, 2019 (IN) 201921031622

(51) Int. Cl. G06Q 10/10; G06Q 50/16; G06T 17/05

(52) U.S. Cl. CPC G06Q 10/101; G06Q 50/16; G06T 17/05

(57) ABSTRACT

The present invention discloses a system and method for an interactive access to project design and space layout planning for real estate and home décor industries. The present invention comprises various system components such as system module (10), property project system (20), designer partner system (30), studio network system (40), execution agency system (50), vendor partner system (60), financial partner system (70), and end user system (80). The system module (10) collects all the required information from other abovementioned systems and serves it to the end user system (80). The system creates a 360° 3DVR view of the product and services of client entity, and allows the end users to experience the live interior and exterior space of the real estate projects and other services before buying. The present invention aids to save time and money of the client as well as end user by implementing completely online computer-based system.

### FIELD OF THE INVENTION

The present invention relates to an interactive access to project design and space layout planning, and more particularly it relates to a system and method for an interactive access to view project design by online and studio network access in 360° three-dimensional and virtual reality (3DVR) for real estate and home décor industries.

### BACKGROUND OF THE INVENTION

A real estate property and home décor becomes known in the marketplace and so the property users or buyers too. A real estate company that sells or constructs buildings such as houses, apartments, shopping malls, commercial complexes, etc. sets up a model or sample house with interior designing in an actual scale corresponding to the building product, and distributes the model or sample house to the user or buyer. The interior construction and the contents of the contract are provided to the buyer within a range that does not greatly change. The typical offline model house used here is only to represent its basic interior structure as an instance, and details about the contents are determined with respect to the buyer's choice. Even if the detail of the apartment space or the interior of the selected apartment which is sold according to the buyer's demand is customized by the customer, the actual residents can not visually confirm the interior that they want. There is a disadvantage that it is impossible to experience the interior environment and interior of the building to be delivered to the user or buyer. Furthermore, since the current housing construction environment and social environment are changing at a rapid pace, buyers are not sensitive to trend changes that the basic model contracted at the time of sale and the actual occupancy model are the same.

In the conventional system, users or buyers of real estate industry and home décor industry are required to physically visit the industry entity to view 360° space layout and design planning of the entity for real life viewing experience. There are cases that the users or buyers which are limited in time or due to some other reasons can not physically visit the property site. Traditional systems of real estate and home décor industry have some limitations such as the potential buyers can not have feel of the live interior and exterior space of project, and similarly the potential developers can not have live experience demo of their real project overview before it built.

Various prior arts have been disclosed describing method for selection and viewing real estate properties. The prior art document U.S. Pat. No. 7,246,044B2 discloses the system which enables a user to implement 3D space design on a computer accessible to a server computer via a network. The server computer includes a layout design program which is operable on a screen activated by a browser of the client computer to enable the user to implement space design of a layout in the terms of a 2D image, an object database which stores object data used for layout design for retrieval and extraction, and a 3D display program which is operable on the browser screen of the client computer to display the designed space in the terms of a 3D image. However, the disclosed system does not relate to, or in any way influence, general interest from the market or feedback from potential buyers relating to a residential construction project during the initial exploration phases.

Another prior art document WO2018039076A1 describes the methods of collecting data include providing immersive and merged reality environments to participants and collecting data from the participants during the environments. Some embodiments of this prior art include a 360° video or photograph or three-dimensional geometry or positional data. In different embodiments, the immersive and merged reality environments include VR, AR, MR, XR, or a combination thereof. However, this is an app and web version invention for multiple participants for data capturing. This is not disclosing the main point of advancement of real view of upcoming project site by aerial vehicle shot integration, and also, this is not allowing personalization on site project real viewer.

Similarly, further prior art document WO2015127534A1 describes a computer-implemented method of real estate sales, where a first step involves positioning on a web page an interactive image of a house that is for sale that enables a potential purchaser to toggle between various interior and exterior views selected from a dollhouse view, a floor plan view, or an individual room plan. A second step involves positioning an interactive furniture display within the various exterior or interior views that enables the potential purchaser to reposition individual pieces of furniture in the interactive furniture display and substitute individual pieces of furniture from a virtual furniture inventory, thereby personalizing the online real estate sales experience. This is only a property model showcasing by 2D, 3D and VR web system which enable buyers to visualize property with interactive web selection of furnishing inventory of vendor.

Above mentioned prior arts do not apparently describe the systems or methods which allow users to view space layout and design framework in 360° 3DVR by easy access form any ware, and also it does not allows user or buyer to experience the project design and space layout in form of virtual reality from the virtual reality studio, mobile QR code, and/or web link. In the current scenario, there is no implementation of using advance viewer technology of 360° 3DVR method process for project design identity by same exterior and interior layout structure which is built in future by real estate and home décor industry.

Therefore, it would be highly desirable to have a completely live or real time viewing experience of the real estate property without physically visiting the property. It is also desirable to select the interior of the house while viewing property via 3DVR technology.

Currently, with the expanding use of the virtual reality (VR) technology and world wide web (WWW) network, there is much possibilities which allow users to view space layout and design framework in 360° 3DVR by easy access form any ware. The users or buyers which are limited in time or due to some reason cannot physically visit the property, in such cases the interior and exterior viewer, allows user or buyer to experience the project design and space layout in form of virtual reality from the virtual reality studio, mobile QR code, and/or web link. This is an ideal way to comfort the users or buyers of the real estate property. Hence, an optimal solution of interactive access into real estate properties has been introduced in the present invention which works as a savior for each and every one in order to eradicate this situation.

### OBJECT OF THE INVENTION

The main object of the present invention is to overcome the problem associated with conventional system and method of buying real estate property by providing an improved system and method of an interactive access to project design and space layout planning for buying real estate property and selecting interior of the property using online interactive platforms.

Another object of the present invention is to provide a system and method for an interactive access to project design and space layout planning which allows end users to experience the live interior and exterior space of real estate project before buying without visiting the project site.

Yet another object of the present invention is to provide a system and method for an interactive access to project design and space layout planning which allows client entity to experience live demo of their respective project overview before it built.

### SUMMARY OF THE INVENTION

The present invention discloses a system and method for an interactive access to project design and space layout planning for real estate and home décor industries. The present invention comprises various system components such as a system module, a real estate property project system, a designer partner system, a studio network system, an execution agency system, a vendor partner system, a financial partner system, and an end user system. The system module collects all the required information from other abovementioned systems and serves it to the end user system. The system creates a 360° 3DVR view of the product and services of client entity, and allows the end users to experience the live interior and exterior space of the real estate projects and other services before buying. It also allows client entity to experience live demo of their real estate project and other services overview before it built. The present invention aids to save time and money of the client as well as end user by implementing completely online computer-based system.

### BRIEF DESCRIPTION OF THE DRAWINGS

Other objects, advantages and novel features of the invention will become apparent from the following detailed description of the present embodiment when taken in conjunction with the accompanying drawings.

FIG. 1 is a block diagram showing the main operational components of an interactive access to project design and space layout planning.

FIG. 2 is a flow diagram illustrating the main operational steps of an interactive access to project design and space layout planning.

FIGS. 2A-2G is flow diagrams illustrating the process followed by different clients for an interactive access to project design and space layout planning.

FIG. 3 is a flow diagram illustrating the variant design module flow of an interactive access to project design and space layout planning.

FIGS. 3A-3C is flow diagrams illustrating the various aspects of the variant interior design module of an interactive access to project design and space layout planning.

### DETAILED DESCRIPTION OF THE INVENTION

Before explaining the present invention in detail, it is to be understood that the invention is not limited in its application to the details of the construction and arrangement of parts illustrated in the accompany drawings. The invention is capable of other embodiment, as depicted in different figures as described above and of being practiced or carried out in a variety of ways. It is to be understood that the phraseology and terminology employed herein is for the purpose of description and not of limitation.

It is also to be understood that the term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also contain one or more other components.

It is to be noted that the term “360° 3DVR” hereinafter stands for the “360° three-dimensional and virtual reality”.

It is further to be understood that the term “Client Entity” hereinafter refers to any one or all of the clients such as designer partners i.e. architect, interior designer, 3D-VR-AI artist, draft man, design coder, and civil engineer; real estate property makers and sellers i.e. developers, land owners, brokers, agents, brand media agency, property marketing and selling agency, and property maker listing platform company; vendor partners i.e. traders, merchants, retailers, distributors, wholesalers, manufacturer, importers and exporters; execution agency i.e. carpenter agency, flooring and construction agency, plumbing agency, color and pop agency, lights and fittings agency, curtain and fabric work agency; studio network i.e. shop, studio, showroom, branch, and office by city, state, and country wise physical network presence; financial institute i.e. central banks, retail and commercial bank, internet banks, credit unions, saving and loan associations, investment banks and companies, brokerage firms, insurance companies, and mortgage companies; and brand partners i.e. manufacturer of any product and services and having distributors, dealers, retailers, traders, and studio network.

The term “End User” hereinafter refers to any one or all of the end users such as new designed property buyers, raw material buyers, interior design package or décor project buyers, consultancy services buyers, and finance and loan buyers.

The term “module” hereinafter refers to an essential piece of computer hardware and an early packaging technique that combined several electronic components to produce a single logic element.

Furthermore, the term “system” hereinafter refers to a framework, be it software and/or hardware, designed to allow software programs to run. Moreover, it is an integrated collection of software and hardware tools to support the development lifecycle, and also represents the basic structure for subsequent implementations.

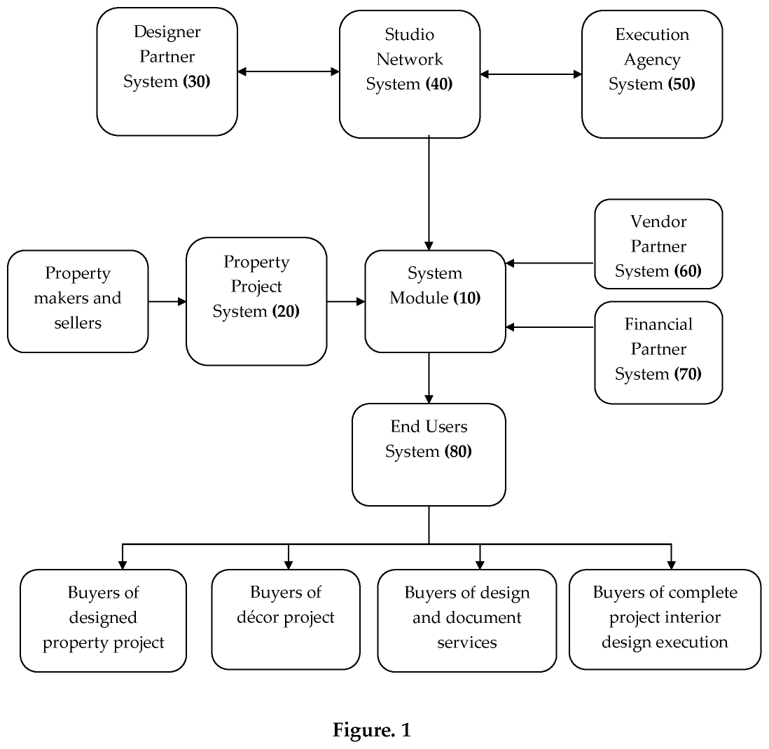

The present invention discloses a system and method for an interactive access to project design and space layout planning for real estate and home décor industries comprises various components and sequential steps to accomplish the objective of the invention. The accompanying drawings show the components and process flow of the interactive access to project design and space layout planning of the present invention. The primary operational components of an interactive access to real estate project are shown in FIG. 1.

Referring to FIG. 1, according to an exemplary embodiment of the present invention, an interactive access system comprising a system module (10), a real estate property project system (20) to store information of property makers and sellers, a designer partner system (30) to store information of designer partner, a studio network system (40) to store information related to studio network tasks, an execution agency system (50) to store executionary information, a vendor partner system (60) to store information of décor products, a financial partner system (70) to store information related to financial services, and an end user system (80) to collect the information from the system module (10) and store information related to end user activities. The system module (10) is a gist of the interactive access system. The system module (10) collects all required information of desired real estate project showcasing, design and document services of interior project, and complete interior project execution services, from the real estate property project system (20) and the studio network system (40). The real estate property project system (20) comprises the information of property makers and sellers. The system module (10) collects all required information of décor product buying services from the vendor partner system (60). The system module (10) further collects all information of financial services available to end users from the financial institute system (70). The designer partner system (30), the studio network system (40), and the execution agency system (50) exchange the information territory wise and feed into the system module (10).

Further, the system module (10) having the information collected from the abovementioned systems, serves all the available services to the territory and project wise end users via the end user system (80), where the end user system (80) collects all the information collected by the system module (10) which then avails the services to the end users.

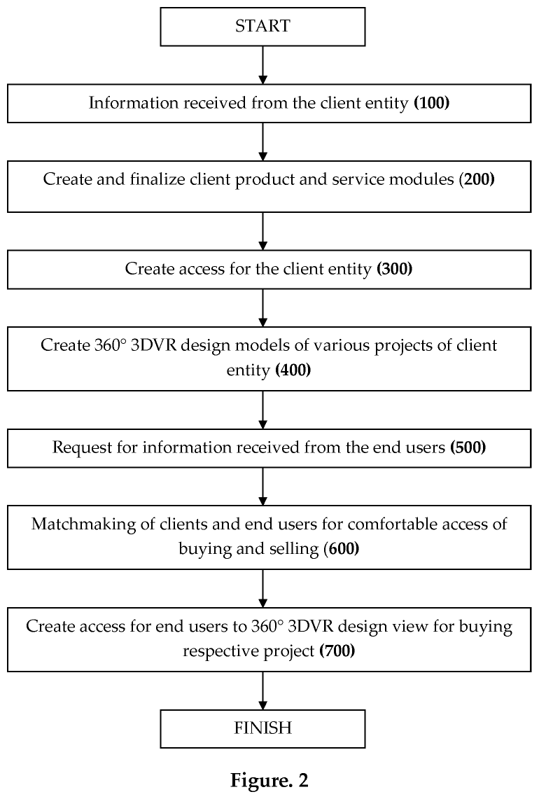

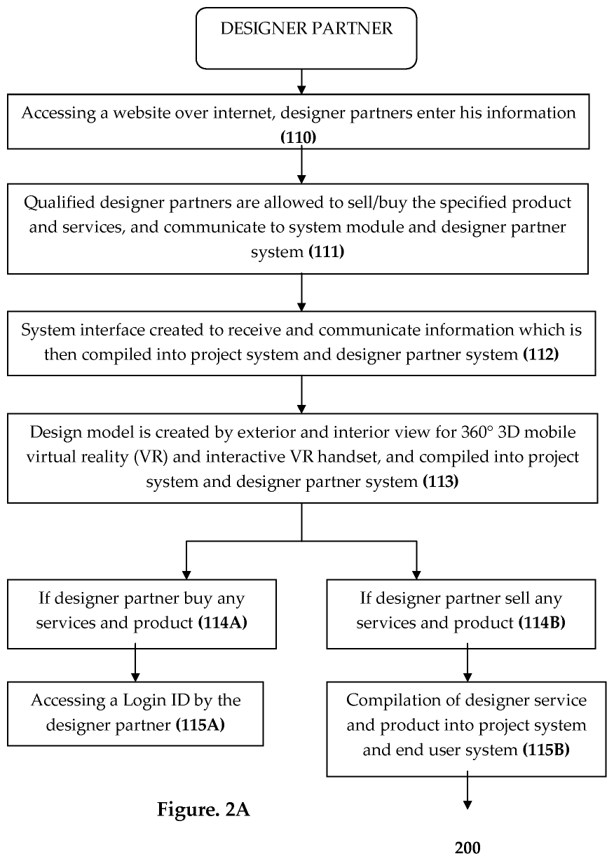

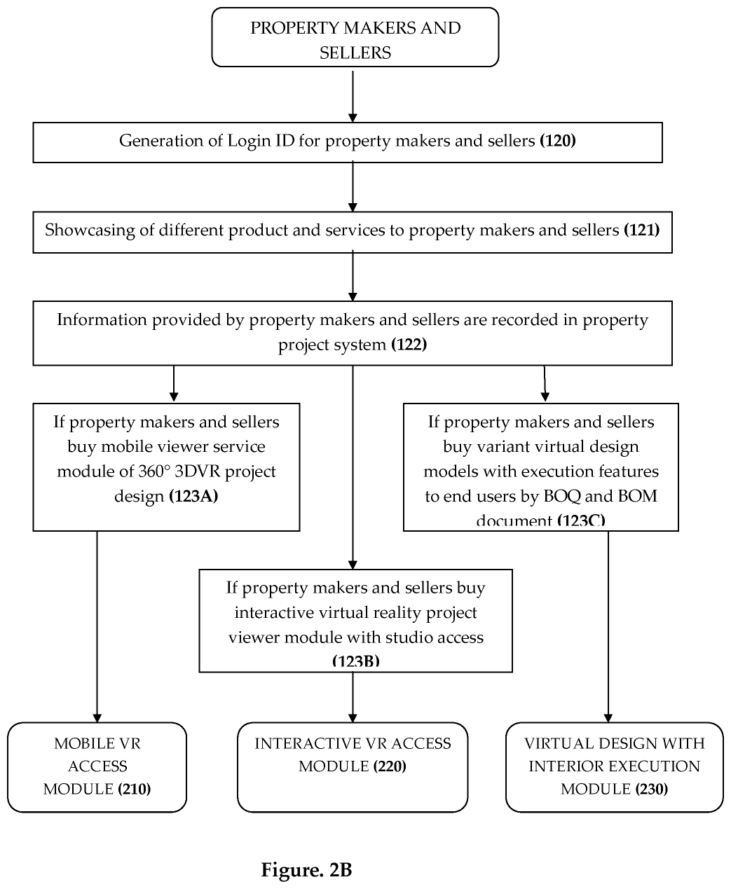

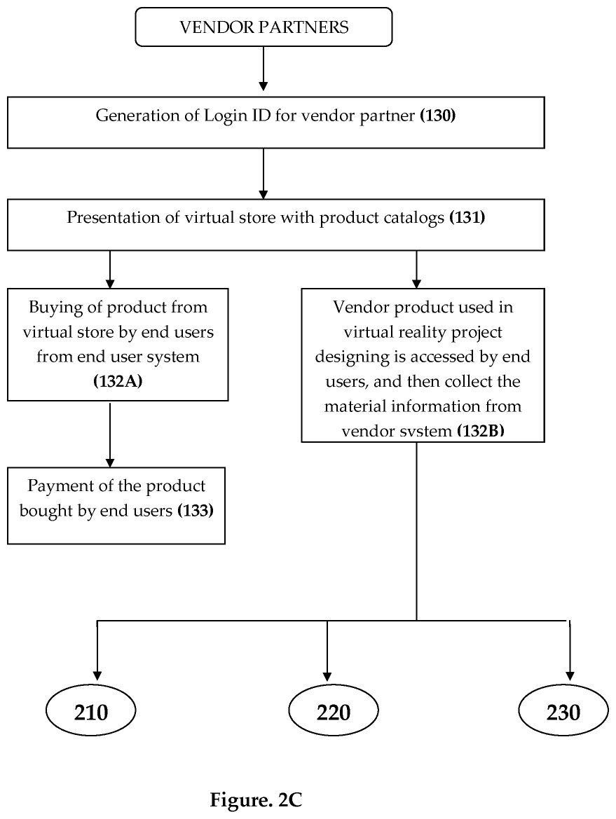

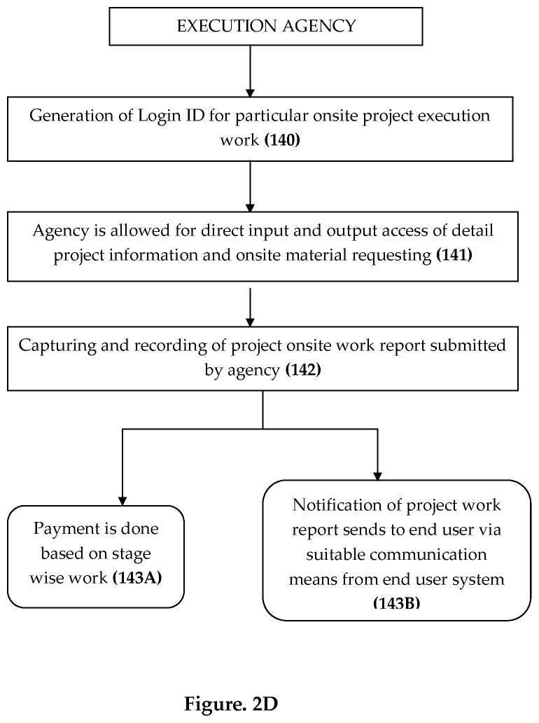

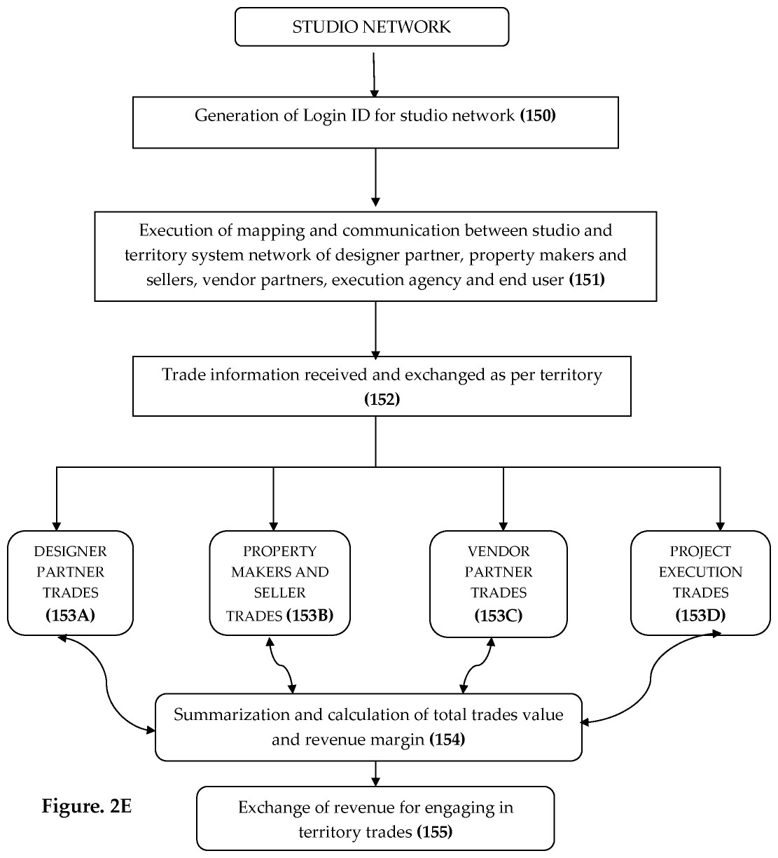

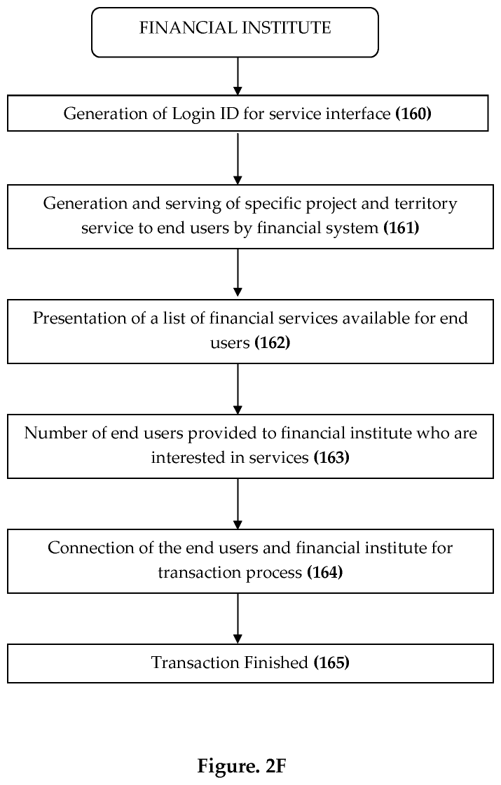

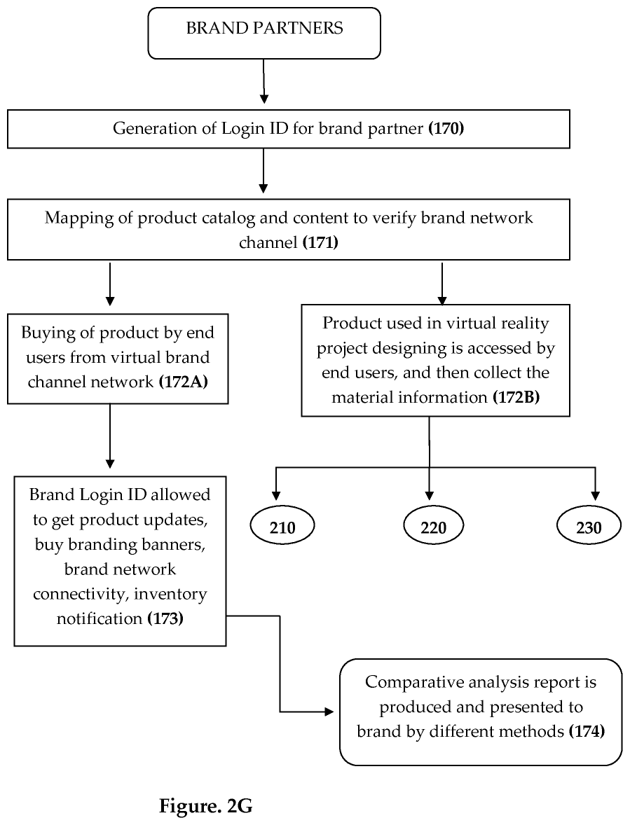

The objective of the present invention will become apparent from the following description of the sequential steps represented by the flow diagrams of the present invention. Referring to FIG. 2, the key steps of an interactive access to real estate project is shown according to other exemplary embodiment of the present invention. In FIG. 2, at input step 100 starting with the process, the system receives pieces of information from the client entity for creating and accessing system, and compiles the information into the system module (10). This is done by accessing the website over internet, or an email, or a physical interaction with client. The client shares his/her name, project name, address and requirements. The system automatically generates the access flow of different services modules for different client entity by geographical territory presence to serve better to end users.

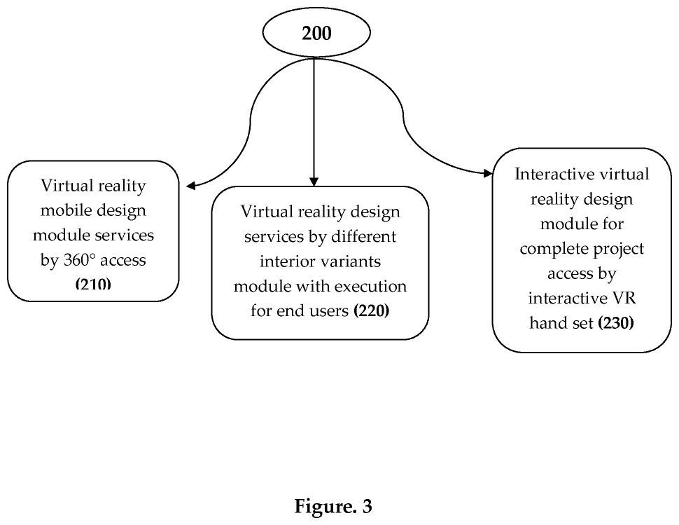

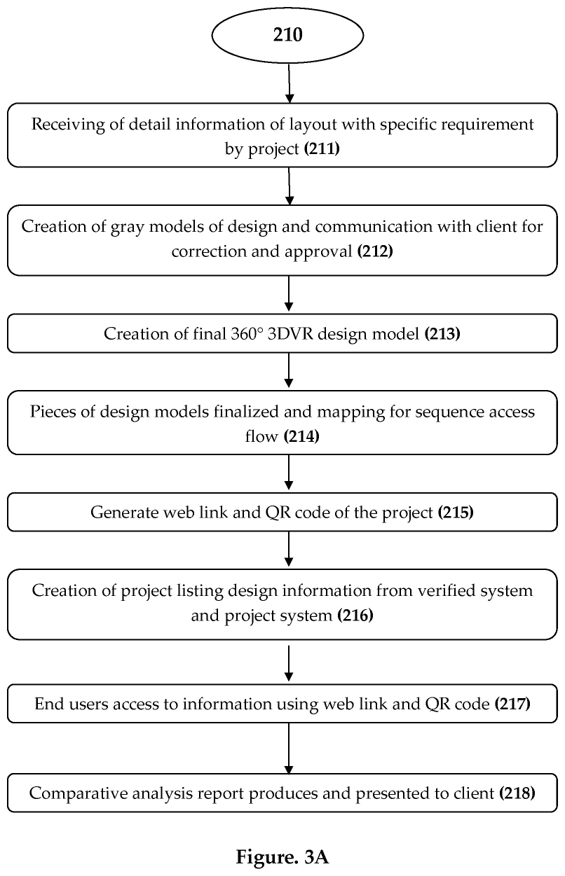

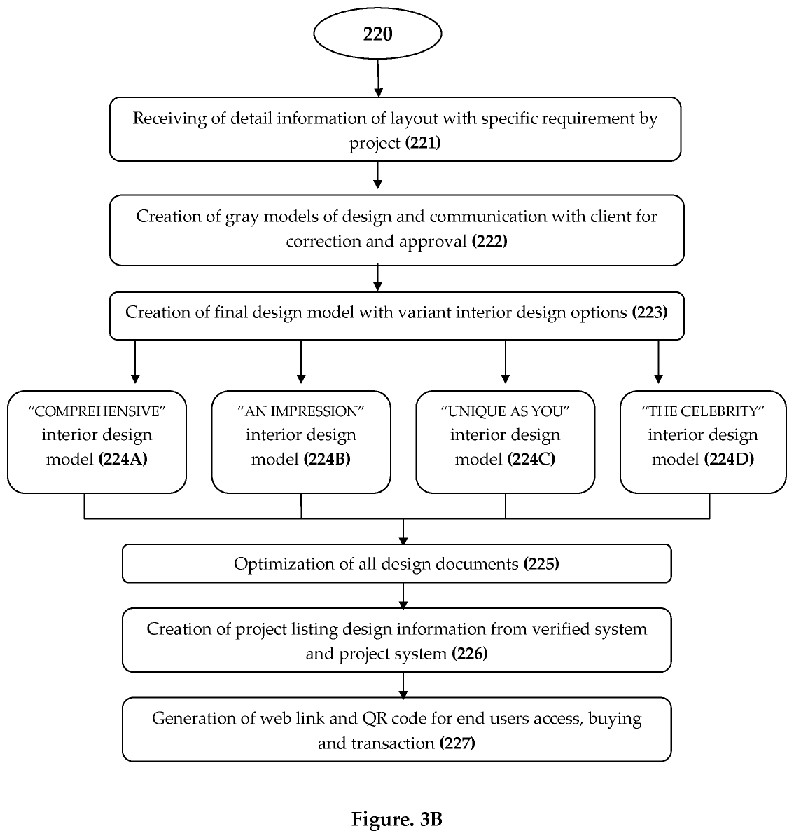

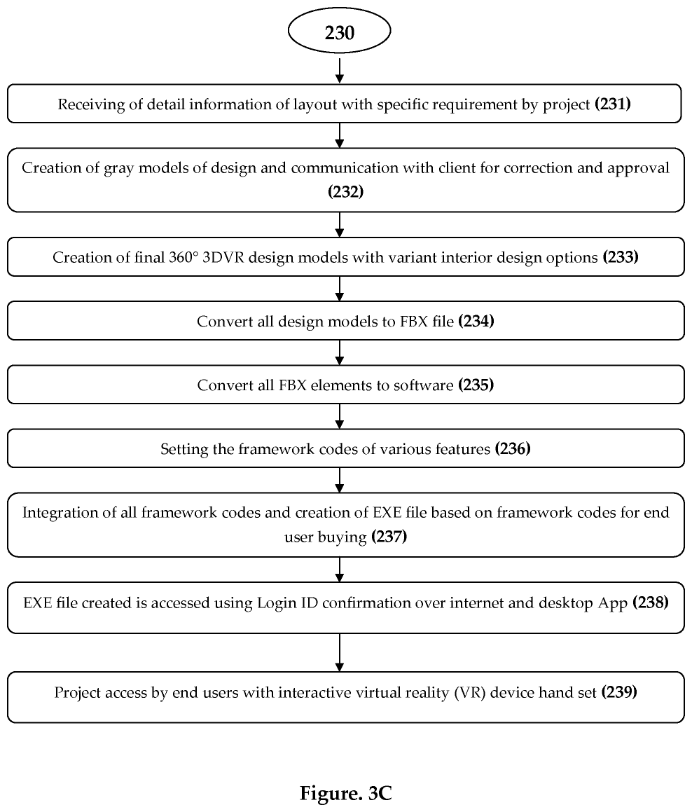

At the input step 200, the system uses all relevant data or information received from the different clients to create and finalize client product and services module, and compiles it into the system module (10) and the end user system (80). At this step, the variant interior design modules are created with different aspects which are elaborated further in FIGS. 3 & 3A-3C. Now, proceeding further towards step 300, a system access for the clients is created after finalizing client product and services, and compiled it into the system module (10) and the end user system (80). At step 400, after providing access to clients in interactive access system, the system creates 360° 3DVR design models of various project design and space layout of client entity before its actual construction using onsite capturing by unmanned aerial vehicle (UAV) in studio network and generates a web link, a QR code, Login ID etc for the end user access at final stage. Here, the unmanned aerial vehicle captures the project design with respect to actual height, width, depth and distance. After that, at step 500, the client starts to receive requests of project information from the end users based on their requirements with respect to various client entities, and it is compiled into the system module (10) and the end user system (80).

After receiving the request from the end users, the system showcases the available product and services to the end users by pin code mapping from the system module (10), and compiles the end user behavior pattern into the end user system (80), where end user behavior pattern is defined based on the response of end users for the product and services. By using the information stored in the system module (10) and execution of match matching algorithm, at step 600 the system matches the recent end user to seller for exact services and product for easy access of buying and selling.

At the final step 700, after the matchmaking of the client and the end user, the system provides an access to the end user for 360° 3DVR view of the different services and products on the web link over internet by email, by scanning QR code, or by registering Login ID. At this point by accessing the 360° 3DVR view of the services and products of the client, the end user experiences the live interior and exterior space of real estate project. It also allows sellers or developers to experience the live demo of their real estate project overview before its actual construction.

FIGS. 2A-2G illustrates the various embodiments of the present invention describing the process followed by different client entities for an interactive access to project design and space layout planning. Starting with FIG. 2A, from step 110, where a designer partner accesses the system via web site over internet or email or physical interaction, and enters his name and features of products and services requirement for the project, then at step 111, the qualified designer partners are allowed to sell/buy the specified products and services, and communicate to the system module (10) and the designer partner system (30). At step 112, a system interface is created to receive and communicate detailed information i.e. detail project drawing, layout plan and material texture as per specification which is then compiled into the real estate property project system (20) and the designer partner system (30). Further at step 113, the system creates the project design model by exterior and interior view for 360° 3D mobile virtual reality (VR) and interactive VR handset, and compiles it into the real estate property project system (20), design system, and the designer partner system (30).

Furthermore, after the 360° 3D mobile virtual reality (VR) session, the two options emerge for the designer partner i.e. buying (step 114A) and selling (step 114B). At step 114A, if designer partner decides to buy any services and product, he needs to proceed towards accessing step 115A where he accesses the Login ID. After logging in, a control panel system and a hyperlink are activated for services and product which he wants to buy, and from there he is directed towards transaction. At step 114B, if designer partner decides to sell any services and product, the system compiles the services and product into the real estate property project system (20) and the end user system (80). After that the process is directed towards terminal 200 i.e. three variant interior design module flow of an interactive access which are described further in FIG. 3.

FIG. 2B describe the process followed by the real estate property makers and sellers for interactive access, where at step 120 the system creates a Login ID of property maker and seller for communication action and compiles it into the system module (10) and the property project system (20). At step 121, the system showcases the different services and product to property maker and seller for buying. After that the maker and seller provides pieces of information regarding services and product to the system. At step 122, the information provided by the maker and seller is recorded in the property project system (20). After this step, there are three different modules are available for property maker and seller which he can buy i.e. 123A, 123B, and 123C. At 123A, if property maker and seller buy a mobile viewer service module of 360° 3DVR project design, he is directed towards “Mobile VR access module” (210). At 123B, if property maker and seller buy a variant virtual design models with execution features to end users by BOQ (bill of quantities) and BOM (bill of materials) document, he is directed towards “Virtual Design with Interior Execution” (220). At 123C, if property maker and seller buy an interactive virtual reality project viewer module with studio access, he is directed towards “Interactive VR access Module” (230). The further process flow of all the three modules i.e. 210, 220, and 230 are described in FIGS. 3A-3C.

Proceeding further towards FIG. 2C, which describing the process followed by the vendor partners for interactive access. At input step 130, the system creates a Login ID of vendor partner and compiles it into the system module (10) and the vendor partner system (60). At step 131, a virtual store with product catalogs and detailed information is presented using a vendor Login control panel. After the presentation of product information, the end user has two options i.e. step 132A and 132B. At step 132A, the end user buys products from the virtual store of the vendor partner via online and offline method using the end user system (80). After buying the product, at step 133, end user makes payment for product bought by him. Further at step 132B, the vendor product used in virtual reality project design is accessed by the end user to obtain material information along with vendor shop name and address. After that, further process is directed towards the three variant interior design modules 210, 220, and 230 which are described in FIGS. 3A-3B.

FIG. 2D describe the process followed by the execution agency for interactive access, where at step 140 the system creates a Login ID for particular onsite project execution work, and compiles it into the system module (10), real estate property project system (20) and the studio network system (40). At step 141, the agency is allowed for direct input and output access of detail information i.e. detail project drawing, BOQ (bill of quantities) and BOM (bill of materials) and onsite material requesting. The agency then generates and submits a weekly work report of onsite work based on abovementioned information. At step 142, the system acquires the report submitted by the agency and records it into the system module (10), the end user system (80), and the studio network system (40). After then, there is an option of payment for stage wise work at step 143A, and other option at step 143B of sending a notification of project work report to the end user via suitable communication means i.e. email, SMS, phone, App, CRM system etc stored in the end user system (80).

FIG. 2E describe the process followed by the studio network for interactive access, where at step 150 the system creates a Login ID for the studio network, and compiles it into the system module (10) and the studio network system (40). At step 151, the system executes the mapping and communication between the studio network and territory system network of designer partner, property makers and sellers, vendor partners, execution agency, and end user. At step 152, the pieces of trade information received and exchanged from the system module (10) and the studio network system (40) as per territory. Here in next step 153, the trade information is classified into four steps i.e. designer partner trades at step 153A, property maker and seller trades at step 153B, vendor partner trades at step 153C, and project execution trades at step 153D. All of the aforesaid trades serve to next step 154, where system summarizes and calculates the total trade's value and revenue margin for studio network territory, and compiled it into the system module (10) and the studio network system (40). Further at step 155, the revenue is exchanged to studio network for engaging completely in the territory trades.

Referring to FIG. 2F, which describes the process flow of the financial institute for interactive access, where at step 160 the system creates a Login ID for service interface, and compiles it into the system module (10) and the financial institute system (70). At step 161, the system allows the financial institute to generate and serve the specific project and territory services to end users. At step 162, the system further presents a list of financial services available for the end users. After reviewing all the financial services in the list presented, the end user decides his interest and at the step 163, the system provides the number of end users to the financial institute who are likely to be interested in the services. Further at step 164, the system connects the end users and financial institute for transaction process and finally the transaction is finished for the interested services at step 165.

Referring to FIG. 2G, which describes the process flow of the brand partners for interactive access, where at step 170 the system creates a Login ID for brand partner, and compiles it into the system module (10) and the vendor partner system (70). At step 171, the system automatically maps product catalog and content to verify brand network channels for reselling in the authorized territory. Proceeding further, there are two options emerged for the end user from the previous step 171 i.e. step 172A and step 172B. At step 172A, the end user can buy the products from virtual brand channel network by online or offline trades, and at step 172B the end user can access the product used in virtual reality project design, and also get the material information with the mapping of brand product information. After step 172A, the system allows brand Login ID to get product updates, brand network connectivity, inventory notification, and buy branding banners at step 173. After step 172B, further process is directed towards the three variant interior design modules 210, 220, and 230 which are described in FIGS. 3A-3B.

At final step 174, a comparative analysis report is produced and presented to the brand by different analysis method such as trend analysis of how fast any product is selling, geographical product weightage and mileage, inventory management, location wise brand network review and rating etc.

Now, referring to FIG. 3, according to an embodiment of the present invention, terminal 200 describing the three variant of interior design module flow of an interactive access which are classified in three terminals i.e. virtual reality mobile design module services by 360° 3DVR access at terminal 210, virtual reality design services by different interior variants module with execution for end users at terminal 220, and interactive virtual reality design module for complete project access by interactive VR hand set at terminal 230.

More specifically, the process flow of the abovementioned terminals i.e. 210, 220, and 230 are described herein FIGS. 3A-3B. Now, referring to FIG. 3A, staring with the input step 211, the system receives detail information such as detail drawing for furniture layout, space layout, exterior elevation, landscape layout with specific requirements by the project. At step 212, the system creates gray models of designs and communicates it to client by project system for correction and final approval. Then, client analyzes the gray model and suggests the corrections if any, or otherwise approves the model for final project. At next step 213, the system creates final 360° 3DVR design models and compiled it into the property project system (20) and the system module (10). After creating the 360° 3DVR design models, the pieces of design models are finalized and mapping for sequence access flow by single method is started at step 214. Further at step 215, the system generates web link and QR code of the project and compiled it into the property project system (20) and the system module (10). At step 216, the system automatically creates project listing design information from the verified system and project system to facilitating the selection of design for end users. At step 217, the end user can have access to the design information using the web link and QR code. After the access of end user, at step 218, the system produces a comparative analysis report and presents it to client for further analysis.

FIG. 3B describing the second variant of interior design module flow of the interactive access system according to the present invention. In FIG. 3B, at input step 221, the system receives detail information such as detail drawing for furniture layout, space layout, exterior elevation, landscape layout with specific requirements by the project. At step 222, the system creates gray models of designs and communicates it to client by project system for correction and final approval. Then, client analyzes the gray model and suggests the corrections if any, or otherwise approves the model for final project. At step 223, the system creates final design models with variant interior design options and compiled it into the property project system (20) and the system module (10). The various interior design models created by the system are “COMPREHENSIVE” interior design model (224A), “AN IMPRESSION” interior design model (224B), “UNIQUE AS YOU” interior design model (224C), and “THE CELEBRITY” interior design model (224D). At step 225, the system optimizes all the design documents including BOQ and BOM documents of all abovementioned interior design models. Further at step 226, after analyzing all the documents the system automatically creates project listing of variant design information from the verified system and project system. And, at step 227, the system generates web link and QR code for end user access for 360° view of design model and if end user decides to buy the model, then money is exchanged and transaction is closed.

Referring to FIG. 3C, describing the third variant of interior design module flow of the interactive access system according to the present invention. At step 231 of FIG. 3C, the system receives detail information such as detail drawing for furniture layout, space layout, exterior elevation, landscape layout with specific requirements by the project. At step 232, the system creates gray models of designs and communicates it to client by project system for correction and final approval. Then, client analyzes the gray model and suggests the corrections if any, or otherwise approves the model for final project. At step 233, after the client's approval, the system creates final 360° 3DVR design models with variant interior design option and compiled it into the property project system (20) and the system module (10). At step 234, the system converts all the design models into FBX file. After that at step 235, the system converts the FBX elements further into software. Now, at the next step 236, the system builds and sets various framework codes according to various property features. Here, the different framework codes are built for the features such as real height/width, distance, lights ON/OFF system, block and floor wise real depth and location view, material texture for variant area view, touch and feel elements, sound engineering, block to floor variant sample view, exterior object like moving car on road, people around lobby, elevator travelling etc, and triggering and walking track.

At step 237, the system integrates all framework codes and creates the EXE file based on framework codes for end user buying, and compiled it into the system module (10), the property project system (20) and the studio network system (40). Further at step 238, the EXE file is accessed by end user via Login ID confirmation over internet and desktop App, and at step 239, the system allows the end user to access the project design in 360° 3DVR view with interactive virtual reality (VR) device hand set.

The system and method of present invention is advantageous over the existing system. The interactive access system of the present invention is provided for Real Estate Industry, Home Décor Industry to view the project design by online or studio network access in 360° 3DVR environment. The studio has one or more enhanced VR features. The system receives a request from the end users to view at least one project design model and the project design model is presented in a 3DVR interactive simulation view to emulate a real life viewing of the project design and space layout planning. Hence, the proposed interactive access system is faster, smoother than current systems.

The above embodiments are described generally in terms of hardware and software. It will be recognized, however, that the functionality of the hardware can be further combined or even separated. The functionality of the software can also be further combined or even separated. Hardware can be replaced, at times, with software. Software can be replaced, at times, with hardware. Accordingly, the present embodiments should not be construed as limiting the scope of the claims here. One of ordinary skill in the art would recognize other variations, modifications, and alternatives. It is inferred that the foregoing description is only illustrative of the present invention and it is not intended that the invention be limited or restrictive thereto. Many other specific embodiments of the present invention will be apparent to one skilled in the art from the foregoing disclosure. All substitution, alterations and modification of the present invention which come within the scope of the following claims are to which the present invention is readily susceptible without departing from the spirit of the invention. The scope of the invention should therefore be determined not with reference to the above description but should be determined with reference to appended claims along with full scope of equivalents to which such claims are entitled.

1. A process of an interactive access to project design and space layout planning, comprising the steps of:
a) receiving the pieces of information of a client through accessing a website over internet, or an email, or a physical interaction with the client to create and access system, and compiling the information into a system module;
b) creating and finalizing a client product and services module, and compiling it into the system module and an end user system;
c) creating a system access for the client, and compiling it into the system module and the end user system;
d) creating a 360° 3DVR design model of project design and space layout of the client before its actual construction through onsite capturing using an unmanned aerial vehicle in studio network;
e) generating a web link, a QR code, and Login ID for the end user access;
f) receiving a request of project information by the client from the end user based on requirements, and compiling into the system module and the end user system;
g) showcasing the available product and services to the end user through pin code mapping from the system module, and compiling the end user behavior pattern into the end user system;
h) matchmaking of the client and the end user for easy access of buying and selling; and
i) providing an access to the end user for 360° 3DVR view of the different services and products of the client through the web link, the QR code, and the Login ID.

2. The process of claim 1, wherein the client information comprises client name, address, project name, and requirements.

3. The process of claim 1, wherein the unmanned aerial vehicle captures the project design with respect to actual height, width, depth and distance.

4. The process of claim 1, wherein the end user behavior pattern is defined based on the response of end users for the client product and services.

5. The process of claim 1, wherein the matchmaking of the client and the end user is executed by match matching algorithm.

6. A system of an interactive access to project design and space layout planning, comprising:
a system module to collect information of desired real estate project showcasing, design and document services of interior project, and complete interior project execution services;
a real estate property project system to store information of property makers and sellers,
a designer partner system to store information of designer partner,
a studio network system to store information related to studio network tasks,
an execution agency system to store executionary information,
a vendor partner system to store information of décor products,
a financial partner system to store information related to financial services, and
an end user system to collect the information from the system module and store information related to end user activities.

7. The system of claim 6, wherein the designer partner system, the studio network system, and the execution agency system exchange the information territory wise, and feed into the system module.

8. The system of claim 6, wherein the end user system further serves the information collected by the system module to the end users.

9. A system of an interactive access to project design and space layout planning configured to operate the steps of claim 1.
